(19) United States
(12) Patent Application Publication
(10) Pub. No.: US 2015/0176319 A1
(43) Pub. Date: Jun. 25, 2015

(54) CAM-TYPE OIL-FREE AUTOMATIC DOOR CLOSER

(71) Applicant: Shen-Fu Huang, New Taipei City (TW)

(72) Inventor: Shen-Fu Huang, New Taipei City (TW)

(21) Appl. No.: 14/135,579

(22) Filed: Dec. 20, 2013

(51) Int. Cl. E05F 1/10

(52) U.S. Cl. CPC E05F 1/105

(57) ABSTRACT

The present invention proposes a cam-type oil-free automatic door closer, installed between a fixed object and door, comprising a first device and second device, wherein the first device comprises a propping rod and the second device is configured with a cam, the propping rod is subjected to an acting force of an elastic element ordinarily to pressed against a working curve of the cam elastically, allowing said propping rod of the first device to be slid along the working curve of the cam relatively to compress the elastic element upon a door opening operation, and the propping rod and the cam to be returned back to original positions thereof to complete a door closing operation when a user releases the door.

### (a) TECHNICAL FIELD OF THE INVENTION

The present invention relates to a cam-type oil-free automatic door closer, and more particularly to a cam-type oil-free automatic door closer including a cam and propping rod.

### (b) DESCRIPTION OF THE PRIOR ART

Current buildings are always facilitated with a door installed with an automatic door closer capable of generating a door closing effect after a user opens the door. Whereby, the user need not carry out a door closing operation, achieving a convenient use.

A conventional common automatic door closer, for example, “automatic door closer structure with buffer” disclosed by Taiwan Patent No. M445064, is mainly constituted by a main body, position limiting seat, elastic element, driving rod, fixing ring, upper and lower connection seats, where a movable door plate is used to link up with the main body to cause the driving rod in the main body to turn to drive the position limiting seat to move and further to compress the elastic element. In the meantime, buffer oil flows into the bottom of the position limiting seat to bring the position limiting seat home when the spring force of the elastic element restores, allowing the position limiting seat to extrude oil to form a buffering effect, and the position limiting seat to have a buffering function when it drives the driving rod and main body to close a door and bring the door home automatically. The main body in the above structure is a hollow body, and first and second locking portions are respectively on the top and bottom of the inner edge thereof; an oil duct in communication with the first and second locking portions is configured in the wall face of the main body and an oil outlet is respectively formed on the locations of the first and second locking portions where the oil duct positions; at least one groove is configured on the upper end of the second locking portion at the inner edge of the main body, and a fixing sheet is locked with the movable door plate is extended out of the main body.

In the conventional automatic door closer mentioned above, a door closing speed is adjusted by adjusting the caliber of the oil outlet to adjust a resistance magnitude exerted on the buffer oil when it flows out, and further to adjust a door closing speed.

Because buffer oil must be used in the structure of the conventional door closer mentioned above, many oil seals need be installed in the whole structure to prevent the buffer oil from leaking. But, a door closer is used very frequently every day such that the oil seats are apt to be damaged and therefore to leak, causing the conventional door closer to lose the cushioning function. Therefore, the conventional door closer in which buffer oil is used as a buffer material is disadvantageous to the extension of use thereof. In addition, because the structure must be kept sealed without oil leak, not only the manufacturing thereof is difficult, but the production cost is increased such that the deficits thereof are apparent.

### SUMMARY OF THE INVENTION

The present invention proposes a cam-type oil-free automatic door closer, installed between a fixed object and door, comprising a first device and second device, wherein the first device comprises a propping rod and the second device is configured with a cam, the propping rod is subjected to an acting force of an elastic element ordinarily to pressed against a working curve of the cam elastically, allowing said propping rod of the first device to be slid along the working curve of the cam relatively to compress the elastic element upon a door opening operation, and the propping rod and the cam to be returned back to original positions thereof to complete a door closing operation when a user releases the door.

The cam is fixed in said second device, the cam is static relatively to said second device, and the propping rod is slid along the working curve of the cam to force the propping rod to move axially through the working curve of the cam so as to store energy in the elastic element upon a door opening or closing operation.

The cam is coupled pivotally to an inside of the second device, allowing the cam to be turned around an axle center thereof to force the propping rod to move through the working curve of the cam to push the propping rod axially and store energy in the elastic element upon a door opening operation.

a front section of the propping rod is configured with a linkage portion in a radial direction, and the propping rod is acted by the elastic element, allowing the linkage portion to be pressed against the working curve of the cam elastically.

The propping rod is acted by the elastic element ordinarily, allowing a top end of the propping rod to be pressed against the working curve of the cam.

The first device includes a pair of clamping components adapted to clamp a door (e.g. glass door) tightly.

At least one positioning portion is configure on the working curve of the cam, allowing the propping rod to be engaged with the corresponding positioning portion, thereby positioning an opened door holding angle of a door temporarily after said door is opened the angle, such as plus or minus 90 degree.

The second device is installed on a door, the cam is coupled pivotally to an inside of the second device, the cam includes a linkage shaft engaged with a spatial linkage, and one end of the spatial linkage is coupled pivotally to a fixed object, allowing the spatial linkage to drive said cam to turn to push the propping rod through the working curve of the cam upon a door opening or closing operation.

The first device includes a first main body, an outer edge thereof is connected fixedly to at least one fixing seat, the first main body is configured with a sliding hole; a propping rod is configured movably in the sliding hole of the first main body, and a linkage portion is configured on the propping rod; an elastic element is installed in the first main body, and adapted to press against the propping rod ordinarily, allowing a front section of the propping rod to be extended out of the first main body ordinarily.

The first main body is configured with an adjustable screw, allowing a tip of the adjustable screw to be compressed against one end of the elastic element. Therefore, an elastic force of the elastic element can be adjusted by rotating the adjustable screw, thereby adjusting a door closing speed of the present invention.

The cam is indented with a positioning shaft hole, a positioning component is engaged with the positioning shaft hole, a wall of the positioning shaft hole is indented with a plurality of positioning holes, said positioning component is engaged elastically with a positioning pin adapted to press against the wall of the positioning shaft hole constantly through a spring, and the positioning component is linked to the first device to turn in the positioning shaft hole.

The top section of the positioning component mentioned above may be engaged with an embedment hole of the first device, allowing the positioning component to be turned in the positioning shaft hole of the cam with the first device upon a door opening operation, and further allowing the propping rod to be engaged with the positioning portion on the working curve of the cam, and the positioning component to be engaged with the positioning hole of the positioning shaft hole of the cam, thereby holding the door at a specific door opening angle stably when the door is opened to a predetermined position (e.g. opened to 90 degree angle).

### BRIEF DESCRIPTION OF THE DRAWINGS

FIG. 1 is an exploded view of a first preferred embodiment according to the present invention;

FIG. 2 is a perspective view of the first embodiment according to the present invention after assembly;

FIG. 3 is a perspective view of the first embodiment in which parts of elements are removed from the structure shown in FIG. 2;

FIG. 4 is a top view of the structure of FIG. 3′

FIG. 5 is a schematic view of the structure of the FIG. 4 after a door is opened 90 degree angle;

FIG. 6 is a schematic view of FIG. 5 upon an automatically door closing operation;

FIG. 7 is a perspective view of a second preferred embodiment according to the present invention;

FIG. 8 is a schematic view of the structure of the second embodiment shown in FIG. 7 when a door is closed; and

FIG. 9 is a schematic view of the second embodiment of the present invention when a door is closed automatically.

### DETAILED DESCRIPTION OF THE PREFERRED EMBODIMENTS

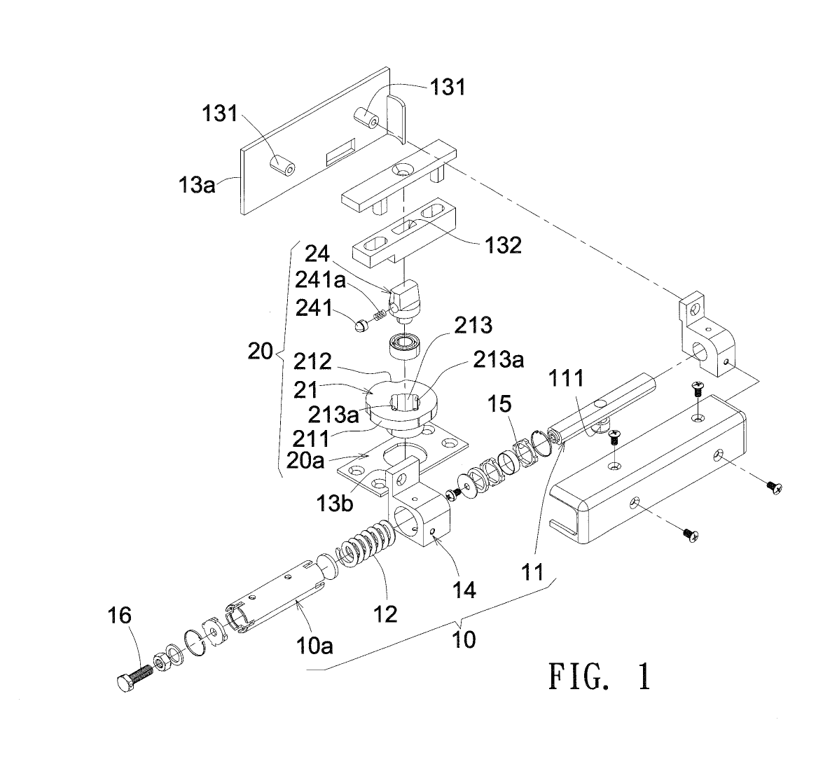

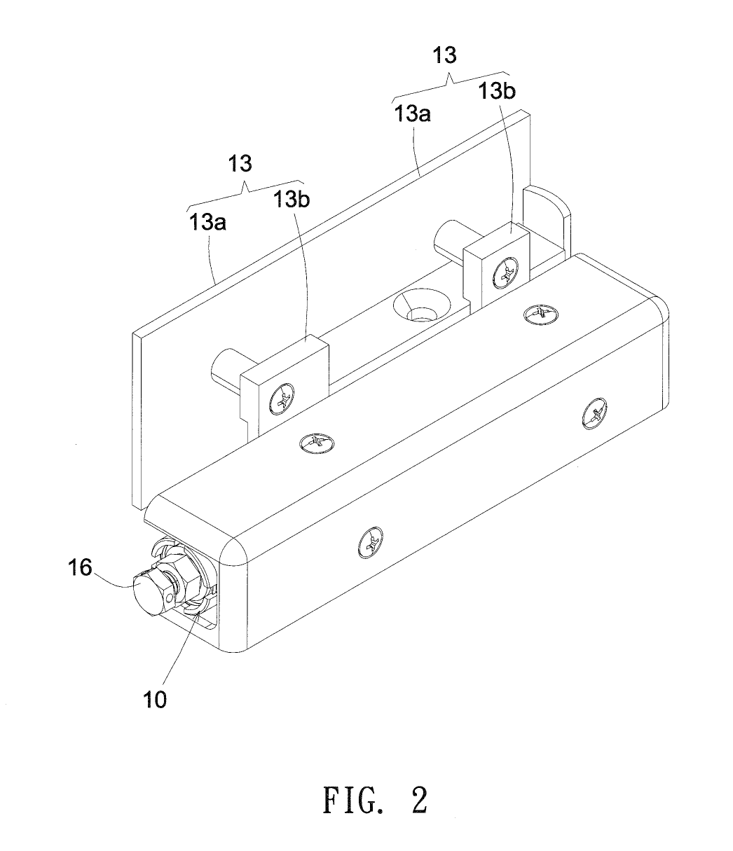

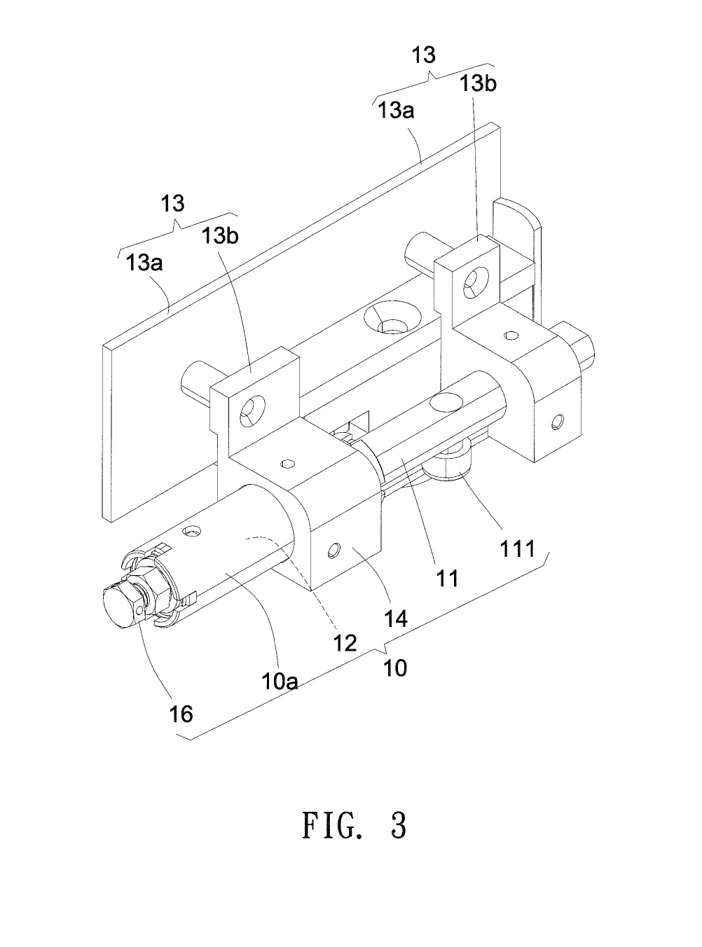

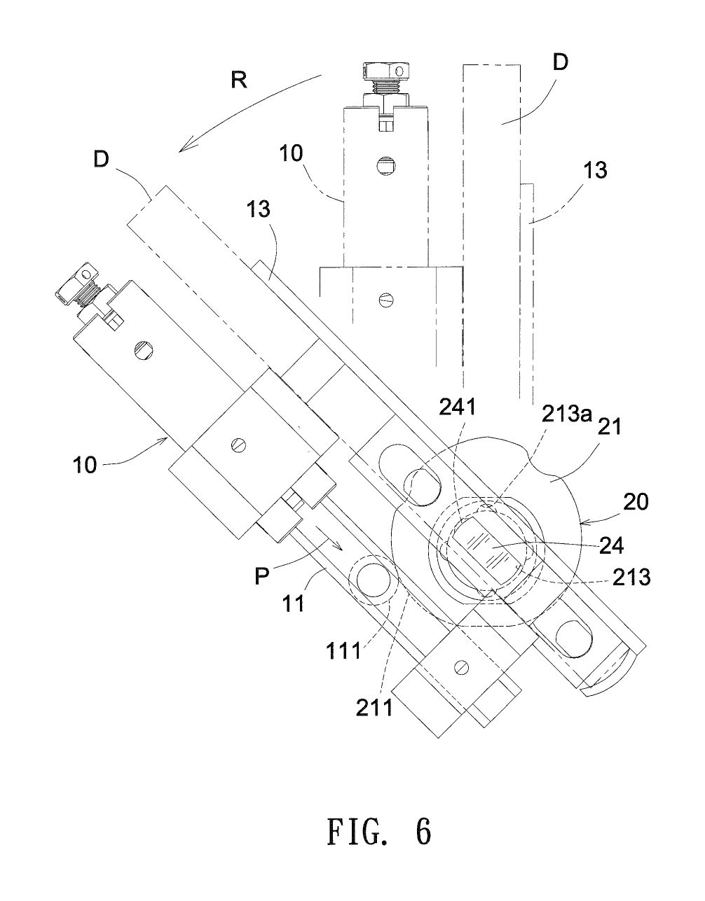

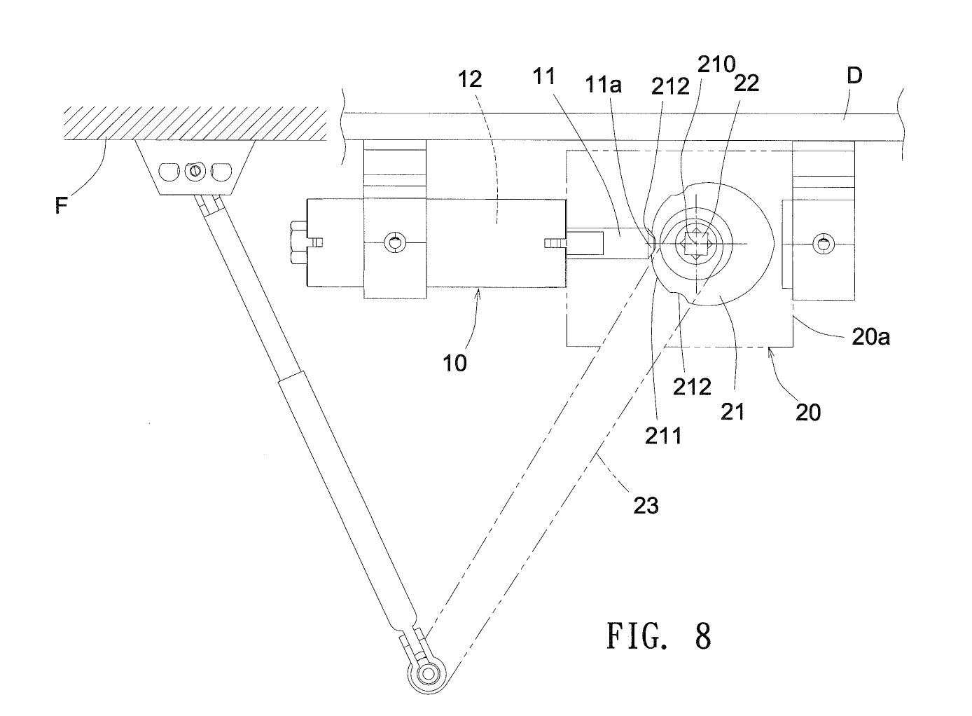

Referring to FIGS. 1 to 9, a cam-type oil-free automatic door closer installed between a fixed object and door, including a first device (10) and second device (20), where the first device (10) includes a propping rod (11), and the second device (20) is configured with a cam (21). An acting force of a elastic element (12) is caused to exert on the propping rod (11) ordinarily, pressing the propping rod (11) against a working curve (211) of the cam (21), allowing the propping rod (11) of the first device (10) to slide along the working curve (211) of the cam (21) relatively to compress the elastic element (12) upon a door opening action, and allowing the propping rod (11) to press against the working curve (211) of the cam (21) of the second device (20) relatively to make the propping rod (11) and cam (21) of the first and second devices (10, 20) to return to their original positions to complete automatic door-closing action through the restoration of the elastic element (12) when a user releases the door.

The cam-type oil-free automatic door closer of the present invention may be a door bow or floor hinge, but the present invention is not so limited.

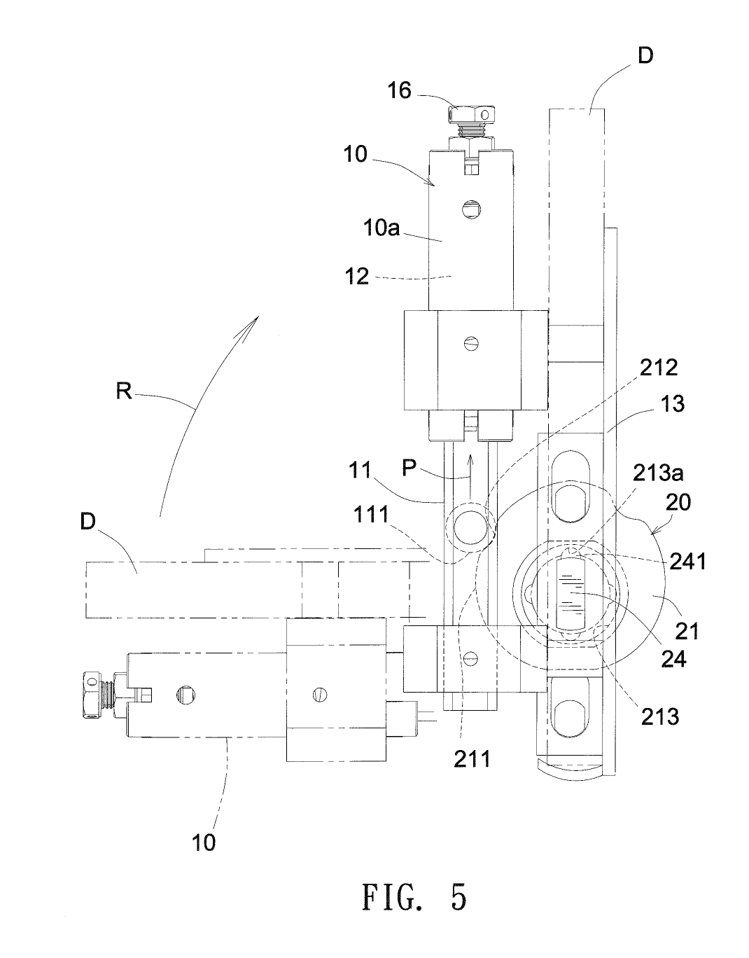

Referring to FIGS. 1, 3 and 4, in the cam-type oil-free automatic door closer disclosed by the present invention, the cam (21) is fixed in a main body (20a) of the second device (20), allowing the cam (21) and second device (20) to be static relatively, and the propping rod (11) to slide along the working curve (21) of the cam (21) in a direction P shown in FIG. 5 upon a door opening operation, thereby forcing the propping rod (11) to move axially to compress the elastic element (12) and thus enable the elastic element (12) to store energy therein.

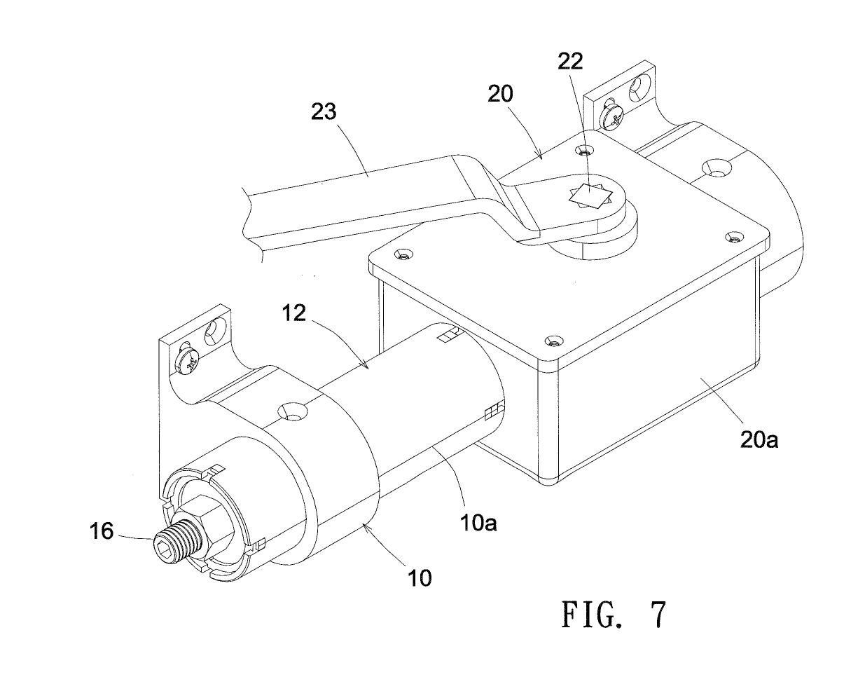

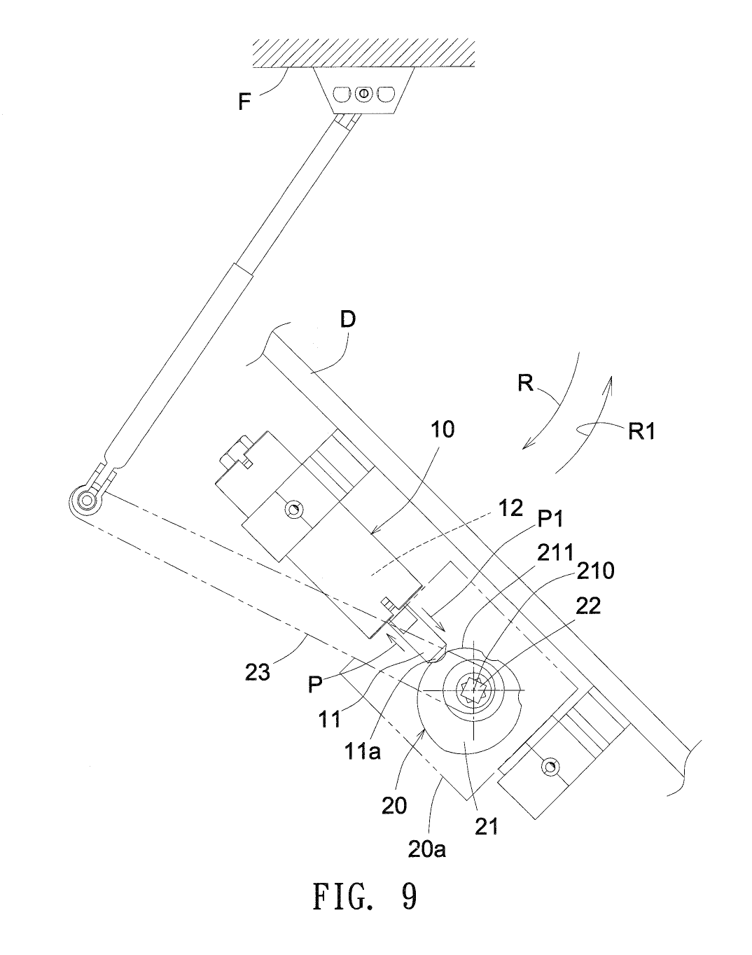

Referring to FIGS. 7, 8 and 9, the cam (21) is coupled pivotally to the main body (20) of the second device (20), allowing the cam (21) to be rotated around an axle center (210) in a direction R shown in FIG. 9, forcing the propping rod (11) to move axially in a direction P shown in FIG. 9 through the working curve (211) of the cam (21), and storing energy in the elastic element (12). Furthermore, the propping rod (11) will push the cam (21) in a direction P1, causing the cam (21) to be turned reversely to generate an automatic door-closing operation in a direction R1 after a user releases the door as FIG. 9 shows.

Referring to FIGS. 1, 3 and 4 again, the front section of the propping rod (11) is configured with a linkage portion (111), and the propping rod (11) is acted by an elastic element (12) to cause the linkage portion (111) to be pressed against the working curve (211) of the cam (21) elastically. In addition, a roller is coupled pivotally to the above linkage portion (111), and the linkage portion (111) is moved on the working curve (211) of the cam (2) through the roller.

The propping rod (11) is acted by the elastic element (12), causing a top end (11a) of the propping rod (11) to be pressed against the working curve (21) of the cam (21).

Referring to FIGS. 1 to 4 again, the first device (10) includes a pair of clamping components (13) for being clamped tightly on a door (D) (e.g. glass door). The pair of clamping components (13) include a first clamping component (13a) capable of being attached to a first side of the door (D), and a second clamping component (13b) a second side thereof, where the first and second clamping components (13a, 13b) are coupled to each other through screws so as to clamp the door (D) between the first and second clamping components (13a, 13b). in addition, projecting pins (131) may be configured on the first clamping component (13a) for being passed through the door (D).

Referring to FIG. 5, at least one positioning portion (212) is configured on the working curve of the cam (21), and the propping rod (11) can be engaged with the corresponding positioning portion (212) after the door (D) is turned an angle to position temporarily an opened door holding angle such as plus or minus 90 degree angle. Furthermore, a user may push the door (d) lightly to cause the propping rod (11) to be pressed against the cam (21) relatively thereby to generate the effect of closing a door automatically because of the elastic restoration of the elastic element (12) after the propping rod (11) and positioning portion (212) are forced to release from each other when the user intends to close the door (D).

Referring to FIGS. 7 to 9, the second device (20) is installed on a door, and the cam (21) is coupled pivotally to the inside of the main body (20a) of the second device (20). The cam (21) includes a linkage shaft (22) engaged with a spatial linkage (23), and one end of the spatial linkage (23) is coupled pivotally to a fixed object (F), allowing the spatial linkage (23) to drive the cam (21) to turn to push the propping rod (11) in the direction (P) through the working curve (211) of the cam (21) to compress the elastic element (12) upon a door opening operation, and further allowing the propping rod (11) to be pressed against the cam (21) in the direction (P1) because of the action of the elastic element (12) to turn the cam (21) reversely in the direction (R1) to generate an automatic door-closing operation after a user releases the door as FIG. 9 shows.

Referring to FIGS. 1, 3 and 4, the first device (10) further includes a first main body (10a), the outer edge of which is coupled fixedly to at least one fixation seat (14) so as to be fixed to a fixed object or door. In addition, a sliding hole (15) is configured on the first main body (10a); the propping rod (11) is movably installed in the sliding hole (15) of the first main body (10a), and a linkage portion (111) is configured on the propping rod (11); the elastic element (12) is installed in the first main body (10a), and press the propping rod (11) elastically ordinarily, causing the front section of the propping rod (11) to be extended out of the first main body (10a) ordinarily.

Furthermore, an adjustable screw (16) is configured on the first main body (10a), where the tip of the adjustable screw (16) is pressed against one end of the elastic element (12) so as to adjust the elastic force of the elastic element (12) by turning the adjustable screw (16), thereby adjusting a door closing speed of the present invention.

The cam (21) is indented with a positioning shaft hole (213), the inside of which a positioning component (24) is engaged with, where a plurality of positioning hole (213a) are indented on the wall of the positioning shaft hole (213), and the positioning component (24) is engaged with a positioning pin (241) propped against the wall of the positioning shaft hole (213) constantly through a spring (241a). Furthermore, the positioning component (24) is linked to the first device (10) to rotate in the positioning shaft hole (213).

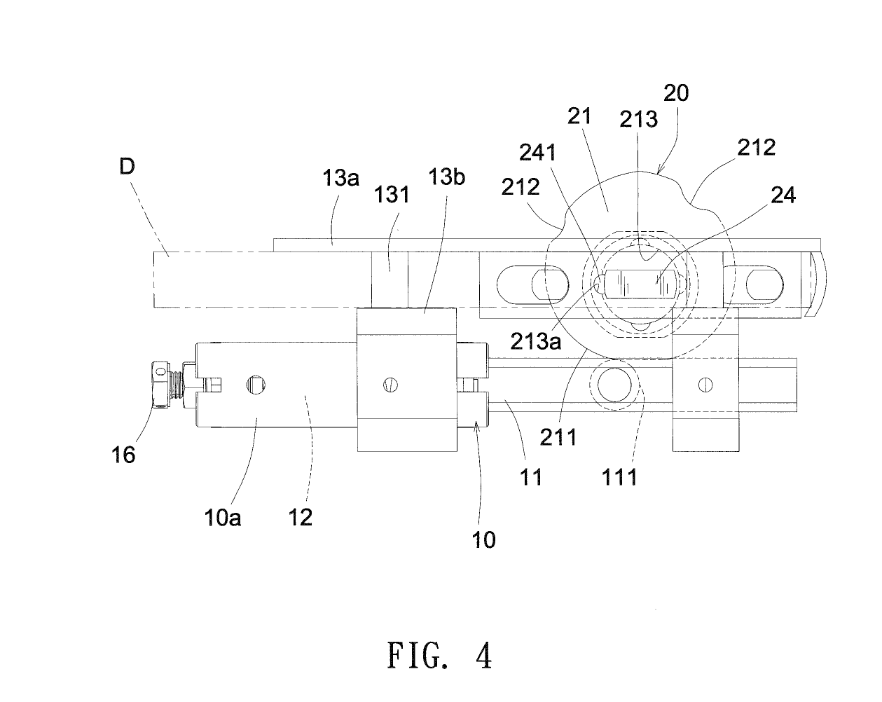

Referring to FIGS. 1 and 4 again, the top section of the positioning component (24) may be engaged with a embedment hole (132) of the first device (10), allowing the positioning component (24) to be turned in the positioning shaft hole (213) of the cam (21) with the first device (10) upon a door opening operation, and further allowing the propping rod (11) to be engaged with the positioning portion (212) on the working curve (211) of the cam (21), and the positioning component (21) to be engaged with the positioning hole (213a) of the positioning shaft hole (213) of the cam (21), thereby holding the door at a specific door opening angle stably when the door is opened to a predetermined position (e.g. opened to 90 degree angle).

The present invention has the following advantages:

1. it is unnecessary to be filled in with hydraulic oil, the present invention has no deficit of oil leak and is environmentally protective.

2. the structure of the present invention is simpler than conventional automatic door closers filled with hydraulic oil, occupies a smaller space and saves the cost.

I claim:

1. A cam-type oil-free automatic door closer, installed between a fixed object and door, comprising a first device and second device, wherein said first device comprises a propping rod and said second device is configured with a cam, said propping rod is subject to an acting force of an elastic element ordinarily to press against a working curve of said cam elastically, allowing said propping rod of said first device to be slid along said working curve of said cam relatively to compress said elastic element upon a door opening operation.

2. The door closer according to claim 1, wherein said cam is fixed in said second device, said cam is static relatively to said second device, and said propping rod is slid along said working curve of said cam to force said propping rod to move axially through said working curve of said cam so as to store energy in said elastic element upon a door opening operation.

3. The door closer according to claim 1, wherein said cam is coupled pivotally to an inside of said second device, allowing said cam to be turned around an axle center thereof to force said propping rod to move through said working curve of said cam to push said propping rod axially and store energy in said elastic element upon a door opening operation.

4. The door closer according to claim 1, wherein a front section of said propping rod is configured with a linkage portion in a radial direction, and said propping rod ia acted by said elastic element, allowing said linkage portion to be pressed against said working curve of said cam elastically.

5. The door closer according to claim 1, wherein a top end of said propping rod is pressed against said working curve of said cam.

6. The door closer according to claim 1, wherein said first device comprises a pair of clamping components clamped on a door, said pair of clamping components comprise a first clamping component clamped on a first side of said door, and a second clamping component attached to a second side of said door, wherein said first and second clamping components are coupled to each other through screws to clamp said door between said first and second clamping components.

7. The door closer according to claim 1, wherein at least one positioning portion is configure on said working curve of said cam, allowing said propping rod to be engaged with said corresponding positioning portion, thereby positioning an opened door holding angle of a door temporarily after said door is opened said angle.

8. The door closer according to claim 1, wherein said second device is installed on a door, said cam is coupled pivotally to an inside of said second device, said cam comprises a linkage shaft engaged with a spatial linkage, and one end of said spatial linkage is coupled pivotally to a fixed object, allowing said spatial linkage to drive said cam to turn to push said propping rod through said working curve of said cam upon a door opening or closing operation.

9. The door closer according to claim 1, wherein said first device comprises a first main body, an outer edge thereof is connected fixedly to at least one fixing seat, said first main body is configured with a sliding hole; a propping rod is configured movably in said sliding hole of said first main body, and a linkage portion is configured on said propping rod; an elastic element is installed in said first main body, and adapted to press against said propping rod ordinarily, allowing a front section of said propping rod to be extended out of said first main body ordinarily.

10. The door closer according to claim 9, wherein said first main body is configured with an adjustable screw, allowing a tip of said adjustable screw to be compressed against one end of said elastic element.

11. The door closer according to claim 1, wherein said cam is indented with a positioning shaft hole, a positioning component is engaged with said positioning shaft hole, a wall of said positioning shaft hole is indented with a plurality of positioning holes, said positioning component is engaged elastically with a positioning pin adapted to press against said wall of said positioning shaft hole constantly through a spring, and said positioning component is linked to said first device to turn in said positioning shaft hole.
